(19) United States
(12) Patent Application Publication
(10) Pub. No.: US 2013/0238881 A1
(43) Pub. Date: Sep. 12, 2013

(54) DATA TRANSMISSION DEVICE, DATA TRANSMISSION METHOD, AND COMPUTER PROGRAM PRODUCT

(71) Applicant: KABUSHIKI KAISHA TOSHIBA, Tokyo (JP)

(72) Inventors: Nobuhiko SUGASAWA, Tokyo (JP); Yuta KOBAYASHI, Kanagawa (JP); Masataka GOTO, Kanagawa (JP)

(73) Assignee: KABUSHIKI KAISHA TOSHIBA, Tokyo (JP)

(21) Appl. No.: 13/787,682

(22) Filed: Mar. 6, 2013

(30) Foreign Application Priority Data
Mar. 7, 2012 (JP) 2012-050790

(51) Int. Cl. G06F 9/30

(52) U.S. Cl. CPC G06F 9/30043
USPC 712/225

(57) ABSTRACT

According to an embodiment, a data transmission device includes a processor, a memory controller, an information memory, a generation unit, and an instruction unit. The memory controller controls read and write operations during data transfer between memory devices. The information memory stores transfer instruction information generated by the processor. The transfer instruction information includes positional information of a position where data is stored in the memory device as read source or a write destination of the data and size information of the data. The generation unit includes divides the transfer instruction information into predetermined data size pieces to generate plural pieces of partial transfer instruction information. The instruction unit instructs the memory controller to acquire a piece of the partial transfer instruction information.

### CROSS-REFERENCE TO RELATED APPLICATION(S)

This application is based upon and claims the benefit of priority from Japanese Patent Application No. 2012-050790, filed on Mar. 7, 2012; the entire contents of which are incorporated herein by reference.

### FIELD

Embodiments described herein relate generally to a data transmission device, a data transmission method, and a computer program product.

### BACKGROUND

A system in which a DMA (Direct Memory Access) controller is provided so as to directly perform transfer control of data between devices, such as memories or hard disks, on behalf of a CPU is heretofore known. The DMA controller controls data transfer between devices based on positional information of a transfer source, positional information of a transfer destination, and transfer instruction information designating a transfer size, which are generated by the CPU. As a method in which the CPU outputs the transfer instruction information to the DMA controller, a method in which the CPU directly writes the transfer instruction information in the register of the DMA controller, or a method in which the CPU stores transfer instruction information in a memory and then the DMA controller reads the transfer instruction information stored in the memory is known. In this way, if data transfer is performed using the DMA controller, since processing by software is not involved in the CPU, it is possible to reduce the processing time of data transfer or to utilize the CPU for other kinds of processing.

However, in the DMA controller, in general, since the CPU generates the transfer instruction information for each piece of data, in the case that data is segmented into small pieces, or the like, it is necessary for the CPU to generate transfer instruction information each time transfer is performed, causing an increase in burden imposed on the CPU.

### BRIEF DESCRIPTION OF THE DRAWINGS

FIG. 1 is a hardware configuration diagram of a data transmission device according to a first embodiment;

FIG. 2 is a schematic diagram of a generation unit according to the first embodiment;

FIG. 3 is a flowchart illustrating the flow of processing for data transfer according to the first embodiment;

FIG. 4 is a sequence diagram illustrating the flow of processing for data transfer according to the first embodiment;

FIG. 5 is a schematic diagram of a generation unit according to a second embodiment;

FIG. 6 is a hardware configuration diagram of a data transmission device according to a third embodiment;

FIG. 7 is a hardware configuration diagram of a data transmission device according to a fourth embodiment;

FIG. 8 is a schematic diagram of a generation unit according to a fifth embodiment; and

FIG. 9 is a sequence diagram illustrating the flow of processing for data transfer according to the fifth embodiment.

### DETAILED DESCRIPTION

According to an embodiment, a data transmission device includes a processor, a memory controller, an information memory unit, a generation unit, and an instruction unit. The memory controller is configured to control read and write operations during data transfer between memory devices that store data. The information memory unit is configured to store therein transfer instruction information generated by the processor. The transfer instruction information includes positional information related to a position where data is stored in the memory device as a read source or a write destination of the data; and size information of the data. The generation unit is configured to divide the transfer instruction information into predetermined data size pieces to generate a plurality of pieces of partial transfer instruction information. The instruction unit is configured to instruct the memory controller to acquire a piece of the partial transfer instruction information.

Various embodiments will be described in detail with reference to the drawings. Although in the embodiments, an example where a data transmission device is applied to a communication device which performs data transmission and reception between different apparatuses will be described, the invention is not limited to the embodiments.

### First Embodiment

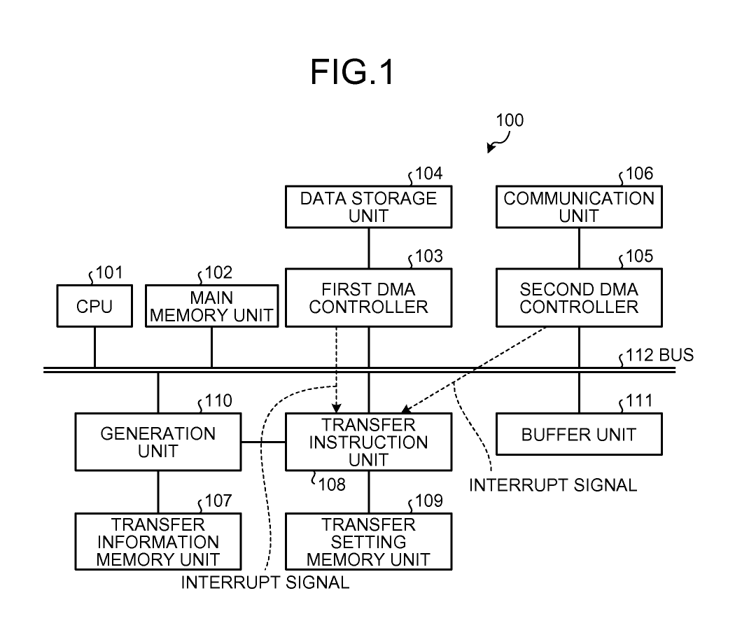

FIG. 1 is a hardware configuration diagram of a data transmission device 100 according to a first embodiment. The data transmission device 100 includes a CPU 101, a main memory unit 102, a first DMA controller 103, a data storage unit 104, a second DMA controller 105, a communication unit 106, a transfer information memory unit 107, a generation unit 110, a transfer instruction unit 108, a transfer setting memory unit 109, and a buffer unit 111. In the first embodiment, the first DMA controller 103 and the second DMA controller 105 correspond to a transfer controller, and a configuration in which two DMA controllers are provided is made. These units are connected together through a bus 112.

The CPU 101 is a unit which executes software stored within the data transmission device 100. Software is usually stored in the data storage unit 104, and when executing software, the CPU 101 usually reads software from the data storage unit 104 and executes software on the main memory unit 102. The CPU 101 generates transfer instruction information for data transfer to be described below. The transfer instruction information is generated when a certain file is operated through software, or the like, and includes memory position information and size information of data per continuously-stored data unit among data pieces constituting the file. Accordingly, the transfer instruction information piece is generated, from a certain file, the number of times equal to the number of pieces of segmented data.

When data is read from the data transmission device 100, the transfer instruction information includes memory position information and size information of data stored in a memory device as a read source. When the data transmission device 100 receives data from another device, and the data is written in an internal memory device, the transfer instruction information includes memory position information and size information of data to be stored in a memory device as a write destination. The transfer instruction information generated by the CPU 101 is stored in the transfer information memory unit 107.

The main memory unit 102 temporarily stores therein machine codes executed by the CPU 101 or data. In the first embodiment, a memory device, such as an SRAM or a DRAM, is used. The data storage unit 104 stores therein nonvolatile data. In the first embodiment, an HDD (Hard Disk Drive) or a high-capacity recording medium, such as an SSD or an SD memory card, is used. The above-described transfer instruction information is generated on the main memory unit 102 once and then stored in the transfer information memory unit 107.

The first DMA controller 103 controls data transfer between the data storage unit 104 and another device. The first DMA controller 103 controls data transfer based on partial transfer instruction information generated from the transfer instruction information to write data acquired from a memory address of the data storage unit 104 designated by the partial transfer instruction information into a memory address designated by another device or to write data acquired from a memory address designated by another device into a designated memory address of the data storage unit 104. The details of the partial transfer instruction information will be described below.

The communication unit 106 is a unit which is used when the data transmission device 100 performs data transmission and reception with an external communication device. In the first embodiment, a communication device according to the communication standard, such as Ethernet (Registered Trademark), USB, or Bluetooth (Registered Trademark), is used. The second DMA controller 105 controls data transfer between the communication unit 106 and another device. The second DMA controller 105 controls data transfer based on the partial transfer instruction information generated from the transfer instruction information to write data acquired from a memory address of the communication unit 106 designated by the partial transfer instruction information into a memory address designated by another device or to write data acquired from a memory address designated by another device into a designated memory address of the communication unit 106.

The transfer information memory unit 107 stores therein the transfer instruction information generated by the CPU 101. In the first embodiment, a storage device, such as an SRAM or a DRAM, is used.

The transfer instruction unit 108 performs the settings of data transfer or interrupt control for the first DMA controller 103 or the second DMA controller 105. Specifically, the transfer instruction unit 108 designates an address in an internal memory unit of the generation unit 110 which is called as a place where partial transfer instruction information to be described below is generated, a read/write direction representing whether data is read or written, and the like for each DMA controller. The transfer instruction unit 108 sets a call address for each DMA controller in advance. The transfer instruction unit 108 receives interrupt signals output from the DMA controllers 103 and 105 and performs interrupt control to the DMA controllers 103 and 105.

The transfer setting memory unit 109 stores therein the settings executed by the transfer instruction unit 108 at the time of data transfer of the DMA controllers 103 and 105 or the procedure of the interrupt control. The transfer instruction unit 108 performs the above-described settings with reference to the transfer setting memory unit 109.

The generation unit 110 has an internal memory unit, and if a reference request to a designated address in the internal memory unit is received from the first DMA controller 103 or the second DMA controller 105, generates and returns partial transfer instruction information in a format according to each of the DMA controllers 103 and 105 from the transfer instruction information stored in the transfer information memory unit 107. Specifically, the generation unit 110 determines a DMA controller where there is a reference in accordance with a called address of the internal memory unit. The generation unit 110 determines the partial size of data set for each DMA controller, additional attribute information, or the like, and generates partial transfer instruction information from the transfer instruction information in terms of called addresses. The generation unit 110 determines from which portion of the transfer instruction information the partial transfer instruction information should be generated, in accordance with the called address.

The partial transfer instruction information may have an array structure or a chain structure depending on the type of DMA controller, and the definition of fields and attribute values also differ. The generation unit 110 changes the format of partial transfer instruction information to be generated depending on the DMA controllers, thereby absorbing a difference in the format of partial transfer instruction information required in the DMA controllers. The transfer instruction unit 108 or the generation unit 110 is implemented by a circuit different from the CPU 101, and accordingly, processing by the transfer instruction unit 108 and the generation unit 110 does not affect the performance of the CPU 101.

The buffer unit 111 temporarily stores therein data when data is transferred between the DMA controllers 103 and 105. Data is delivered via the buffer unit 111. In the first embodiment, as the buffer unit 111, like the main memory unit 102, a storage device, such as an SRAM or a DRAM, is used.

The bus 112 connects the respective units, and in the first embodiment, an example in which the units are connected by a single bus is described. The bus 112 is connected according to the standard, such as a PCI bus, and the respective units perform data communication through the bus 112.

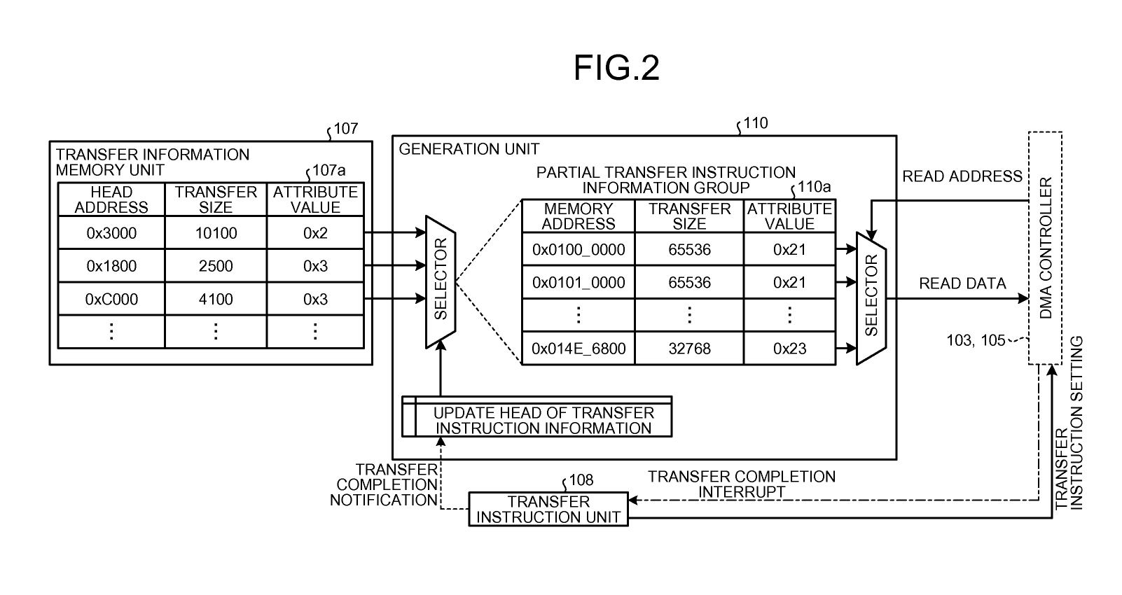

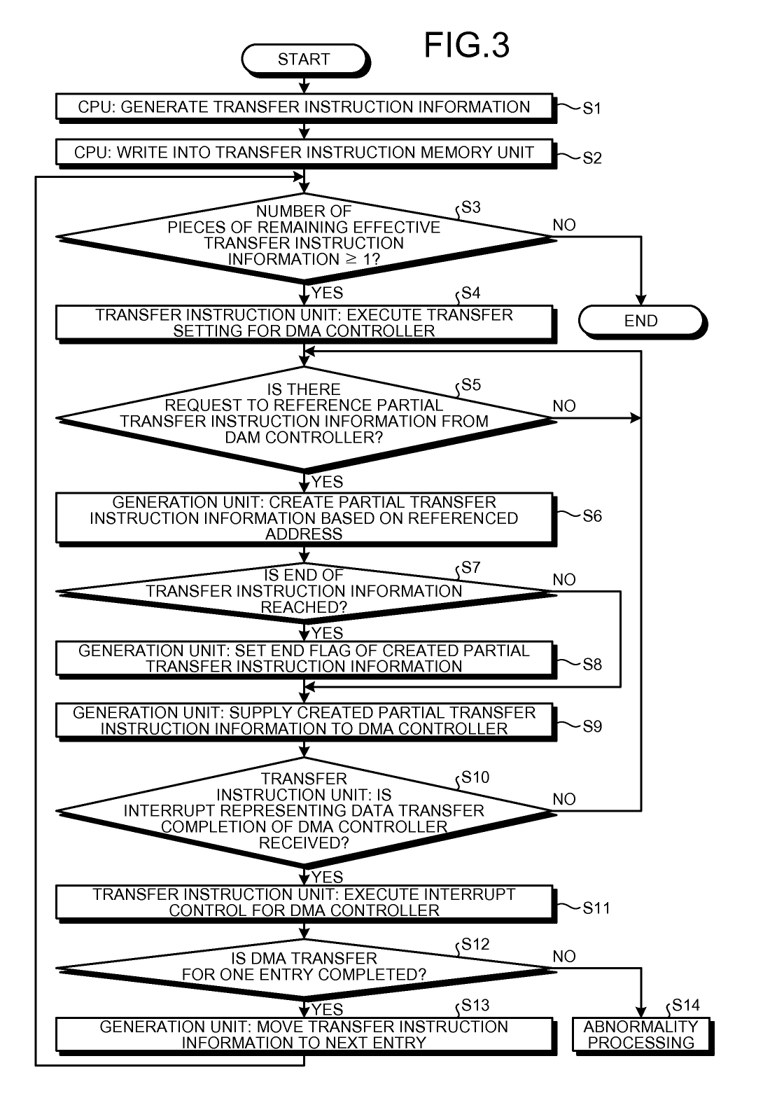

FIG. 2 is a diagram illustrating the details of processing related to the generation unit 110 according to the first embodiment. FIG. 3 is a flowchart illustrating the flow from the generation of transfer instruction information to the processing for data transfer in each of the DMA controllers 103 and 105. The flow of the processing will be described with reference to FIGS. 2 and 3. First, the CPU 101 generates transfer instruction information on the main memory unit 102 (Step S1). Next, the CPU 101 writes the generated transfer instruction information in the transfer information memory unit 107 (Step S2). As illustrated in FIG. 2, the transfer information memory unit 107 stores therein a transfer instruction information table 107a. The transfer instruction information generated by the CPU 101 is stored in the format of the transfer instruction information table 107a, and the transfer instruction information table 107a has three fields of “head address,” “transfer size,” and “attribute value.” The head address corresponds to the above-described memory position information of data, and the transfer size corresponds to the size information. The transfer instruction information table 107a in the first embodiment illustrates transfer instruction information for data transfer when data stored in the data storage unit 104 is read or when data is newly written into the data storage unit 104. However, the transfer instruction information is also generated for another device, which can store data, as well as the data storage unit 104, and the data structure differs between the memory devices.

The first entry of the transfer instruction information table 107a illustrated in FIG. 2 represents that data of 10100 blocks starting from the address 0x3000 is transfer-target data. In regard to the attribute value, “0x2” represents the read of data from the data storage unit 104, and “0x3” represents the write of data in the data storage unit 104. The entry of the transfer instruction information to be selected in the transfer instruction information table 107a is determined by the generation unit 110, and a selector circuit controls the selection based on a signal input from the generation unit 110.

As the attribute value, information, such as a flag representing whether an entry is effective, may also be set. As the attribute value of the transfer instruction information, a timer value is put, and a break of data transfer may be inserted between a certain entry of certain transfer instruction information and another entry. With this, intermittent data transfer can be performed, thereby allowing an operation with lower power consumption.

Next, the transfer instruction unit 108 determines whether there are one or more pieces of effective transfer instruction information when the settings of data transfer for the first DMA controller 103 or the second DMA controller 105 are performed, that is, when an instruction to start actual data transfer is issued from software (Step S3). When there are one or more pieces of effective transfer instruction information (Yes in Step S3), that is, when there is data being executed by an operation, such as open, by software, the transfer instruction unit 108 sets, as transfer setting information of data, all conditions necessary for transferring the address of the generation unit 110 for the first DMA controller 103 or the second DMA controller 105 (Step S4). With the setting of the transfer setting information, when the first DMA controller 103 or the second DMA controller 105 attempts to start to transfer data and issues a reference request to the generation unit 110, the head of the designated address of the generation unit 110 becomes a reference start position.

FIG. 2 illustrates a situation in which the generation unit 110 points to the first entry of the transfer instruction information table 107a. Which entry is being pointed is set by the generation unit 110, and after the generation unit 110 generates the partial transfer instruction information, a pointer is moved to the next entry. In this situation, the generation unit 110 determines whether there is a reference request of the partial transfer instruction information from the first DMA controller 103 or the second DMA controller 105 (Step S5). When it is determined that there is a reference request of the partial transfer instruction information (Yes in Step S5), the generation unit 110 generates partial transfer instruction information corresponding to the referenced address based on the transfer instruction information (Step S6).

Next, the generation unit 110 determines whether the generated partial transfer instruction information is the end of data in a certain entry (Step S7). When it is determined that the partial transfer instruction information is the end of data in the entry (Yes in Step S7), the generation unit 110 sets the value of “0x23” in the field of the attribute value of the generated partial transfer instruction information, that is, a flag representing the end (Step S8). The first DMA controller 103 and the second DMA controller 105 can determine whether all piece of partial transfer instruction information have been acquired, by referring to the attribute value of the referenced partial transfer instruction information.

When it is determined that the partial transfer instruction information is not the end of data in the entry (No in Step S7), the generation unit 110 outputs the generated partial transfer instruction information to the DMA controller 103 or 105 that has referred thereto without setting the flag representing the end (Step S9).

A partial transfer instruction information group 110a illustrated in FIG. 2 represents a plurality of pieces of partial transfer instruction information generated from the first entry of the transfer instruction information. In the first embodiment, the transfer instruction information is divided per a data size of 65536, and the partial transfer instruction information of the end has a data size of excess “32768.” The partial transfer instruction information has three fields of “memory address,” “transfer size,” and “attribute value.” In the first embodiment, “0x21” is used as the attribute value of the partial transfer instruction information other than the end from among partial transfer instruction information generated from transfer instruction information of a certain entry, and “0x23” is used as the attribute value of the partial transfer instruction information of the end. Since the definitions of these attribute values differ between the DMA controllers, the generation unit 110 determines the attribute value in conformity with the DMA controller.

As illustrated in FIG. 2, if the data transfer of all pieces of data of the partial transfer instruction information group 110a is completed, each of the DMA controllers 103 and 105 outputs a transfer completion interrupt signal to the transfer instruction unit 108. Each of the DMA controllers 103 and 105 determines whether all pieces of partial transfer instruction information are acquired from information of the end flag in the partial transfer instruction information.

As illustrated in FIG. 3, the transfer instruction unit 108 determines whether an interrupt signal representing the completion of data transfer output from each of the DMA controllers 103 and 105 is input (Step S10). When the interrupt signal is input (Yes in Step S10), the transfer instruction unit 108 performs interrupt control to the DMA controllers 103 and 105 (Step S11). When the interrupt signal is not input (No in Step S10), that is, when all pieces of the partial transfer instruction information are not yet output from the DMA controllers 103 and 105 where there is a reference, the processing from Step S5 is repeated, and the generation unit 110 generates partial transfer instruction information in accordance with the reference request from each of the DMA controllers 103 and 105. The generation unit 110 receives a reference request to the next address subsequent to the address of the generation unit 110 referenced in the flow of the previous processing from each of the DMA controllers 103 and 105.

Next, the transfer instruction unit 108 determines whether data transfer for one entry stored in the transfer instruction information table 107a to be processed is normally completed from the interrupt signal representing the completion of data transfer by each of the DMA controllers 103 and 105 (Step S12). The interrupt signal includes abnormality detection information representing whether transfer is normally completed. If it is determined that data transfer for one entry is normally completed (Yes in Step S12), the generation unit 110 receives a transfer completion notification from the transfer instruction unit 108, and updates the position of the entry to the next entry in the transfer instruction information table 107a (Step S13). If it is determined that data transfer for one entry is not normally completed (No in Step S12), the transfer instruction unit 108 performs abnormality processing (Step S14). The abnormality processing is to display an error in data transfer on a screen.

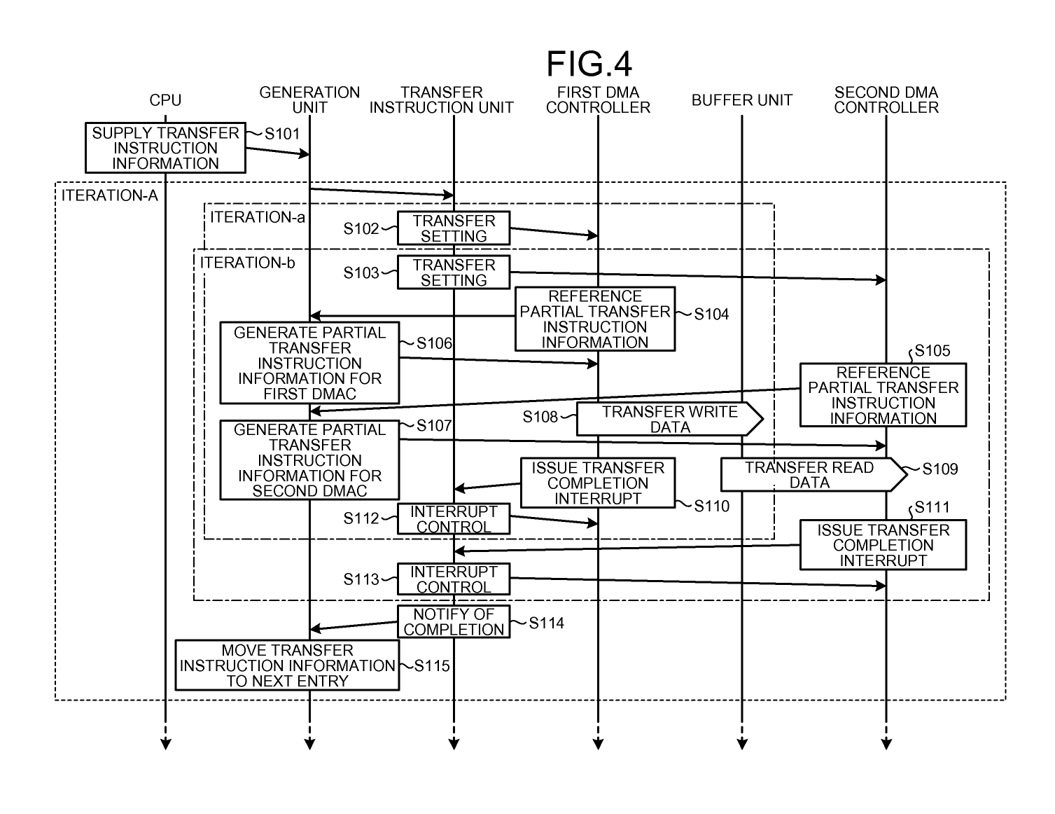

Next, the flow of processing for data transfer will be described with reference to FIG. 4 which is a sequence diagram when data transfer is performed between the first DMA controller 103 and the second DMA controller 105. FIG. 4 illustrates a case where data transfer is performed from the first DMA controller 103 to the second DMA controller 105. First, the CPU 101 creates transfer instruction information in the main memory unit 102 when executing data transfer, and writes the transfer instruction information in the transfer information memory unit 107 through the generation unit 110 (Step S101). Although not illustrated, it is assumed that all settings necessary for operating the transfer instruction unit 108, for example, transfer activation and the like are executed by the CPU 101 in advance.

Subsequently, the sequence of “iteration a” and the sequence of “iteration b” of FIG. 4 are sequentially advanced. If there is an effective entry in the transfer information memory unit 107, the transfer instruction unit 108 performs the transfer settings of the first DMA controller 103 and the second DMA controller 105 (Steps S102 and S103). If the transfer settings are made, the first DMA controller 103 and the second DMA controller 105 perform read access to the address of the generation unit 110 set by the transfer instruction unit 108, and references partial transfer instruction information (Steps S104 and S105).

If a reference request to the partial transfer instruction information is received from the first DMA controller 103 and the second DMA controller 105, the generation unit 110 determines which DMA controller has made the reference based on the designated address. The generation unit 110 generates partial transfer instruction information according to the specification of the DMA controller, and outputs the partial transfer instruction information to the first DMA controller 103 and the second DMA controller 105 (Steps S106 and S107).

The first DMA controller 103 writes data in the buffer unit 111 in accordance with the partial transfer instruction information (Step S108). The second DMA controller 105 waits because data transfer is not performed during a period in which there is no data written in the buffer unit 111, and if data is written in the buffer unit 111, executes data transfer to read data in the buffer unit 111 (Step S109). As described above, when the end flag of the attribute value of the referenced partial transfer instruction information is set, the first DMA controller 103 and the second DMA controller 105 end data transfer using the partial transfer instruction information and then output a transfer completion interrupt signal to the transfer instruction unit 108 (Steps S110 and S111). The transfer instruction unit 108 performs interrupt control for the first DMA controller 103 and the second DMA controller 105 (Steps S112 and S113).

The transfer instruction unit 108 repeats the transfer settings to the first DMA controller 103 and the second DMA controller 105 until data transfer for a size designated by the entry of the transfer instruction information is completed, and the first DMA controller 103 and the second DMA controller 105 repeat data transfer based on the transfer settings (iteration a and iteration b).

If data transfer using the first DMA controller 103 and the second DMA controller 105 is completed, the transfer instruction unit 108 notifies the generation unit 110 of transfer completion (Step S114). Finally, if the transfer completion notification is received, the generation unit 110 moves the reference destination of the transfer information memory unit 107 to the next entry (Step S115). The processing of Steps S102 to S115 is repeated until data transfer related to all entries stored in the transfer information memory unit 107 is completed (iteration A).

In the first embodiment, in the transfer instruction unit 108 and the generation unit 110 which are implemented by circuits different from the CPU 101, the DMA controllers performs generating partial transfer instruction information required at the time of data transfer. For this reason, for example, it is not necessary that data of a file is segmented and the CPU 101 generates a large number of pieces of partial transfer instruction information. Therefore, the CPU 101 generates only the transfer instruction information, thereby reducing burden imposed on the CPU 101.

### Second Embodiment

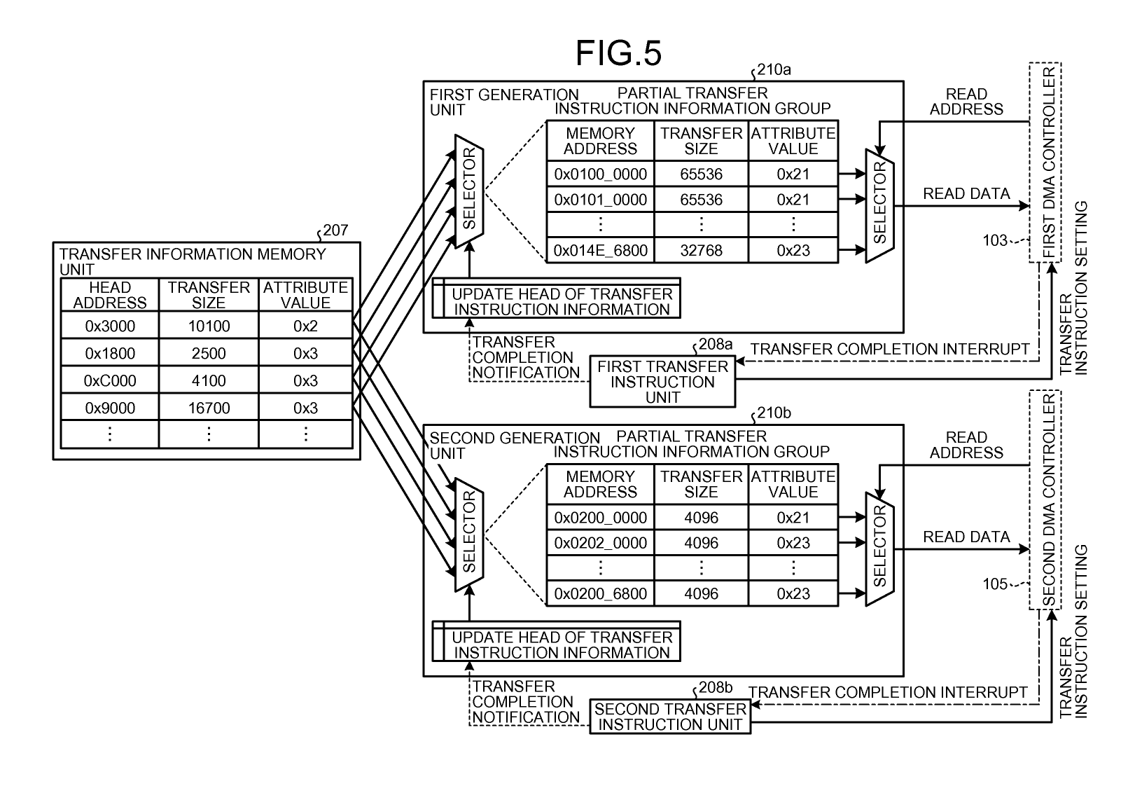

Next, a second embodiment of a data transmission device will be described. In the second embodiment, as illustrated in FIG. 5, separate generation units and transfer instruction units are provided in a first DMA controller 103 and a second DMA controller 105. As illustrated in FIG. 5, a first transfer instruction unit 208a and a first generation unit 210a are provided corresponding to the first DMA controller 103. A second transfer instruction unit 208b and a second generation unit 210b are provided corresponding to the second DMA controller 105. A generation unit 210a selects the first entry in a transfer information memory unit 207, and a generation unit 210b selects the fourth entry in the transfer information memory unit 207.

For example, in the case of data transfer in which data is read from a data storage unit 104 connected to the first DMA controller 103, and data is transmitted from a communication unit 106 connected to the second DMA controller 105, the data transfer rate or the data size to be transferred per single data transfer may differ. In this case, if data transfer between memory devices is executed using one set of a generation unit and a transfer instruction unit, since the processing should be performed in conformity with a lower rate, throughput is sacrificed. Accordingly, separate generation units and transfer instruction units are provided in the DMA controllers, and each of the DMA controllers can perform data transfer at the corresponding transmission rate or in the corresponding data size, thereby suppressing degradation in throughput.

### Third Embodiment

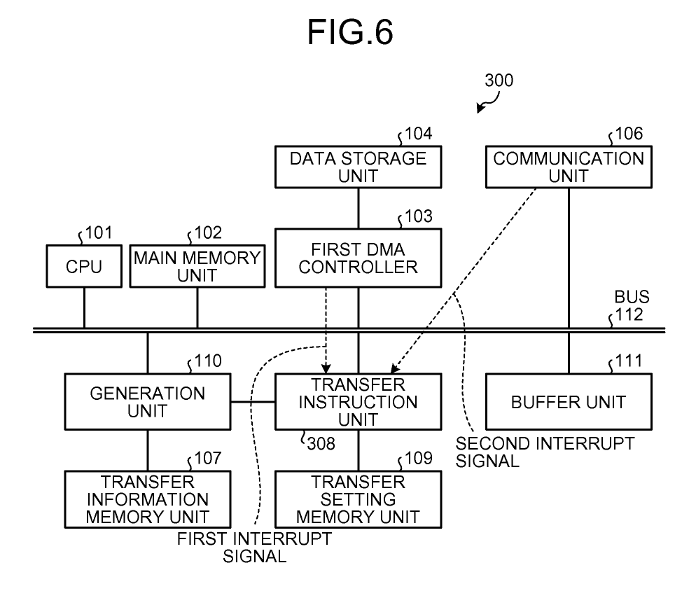

A third embodiment will be described. In the third embodiment, a case where a second DMA controller 105 for data exchange with a communication unit 106 is not provided and a transfer instruction unit 108 directly performs data transfer is described. FIG. 6 is a hardware configuration diagram of a data transmission device 300 according to the third embodiment, and a communication unit 106, and a transfer instruction unit 308 are directly connected by a bus 112.

In the third embodiment, at the time of data exchange with the communication unit 106, unlike the first and second embodiments, the transfer instruction unit 308 does not perform transfer settings, such as the setting of the address of the partial transfer instruction information to the second DMA controller 105, and directly makes a reference request of the partial transfer instruction information to a predetermined address of a generation unit 110. The transfer instruction unit 308 executes data transfer with the communication unit 106 based on the partial transfer instruction information generated by the generation unit 110.

Accordingly, it is not necessary to generate partial transfer instruction information for the communication unit 106, and one set of a generation unit and a transfer instruction unit would be sufficient.

### Fourth Embodiment

In a fourth embodiment, two buses 412a and 412b are used, and a transfer instruction unit 408, a generation unit 410, and a buffer unit 411 have ports for each of the buses 412a and 412b.

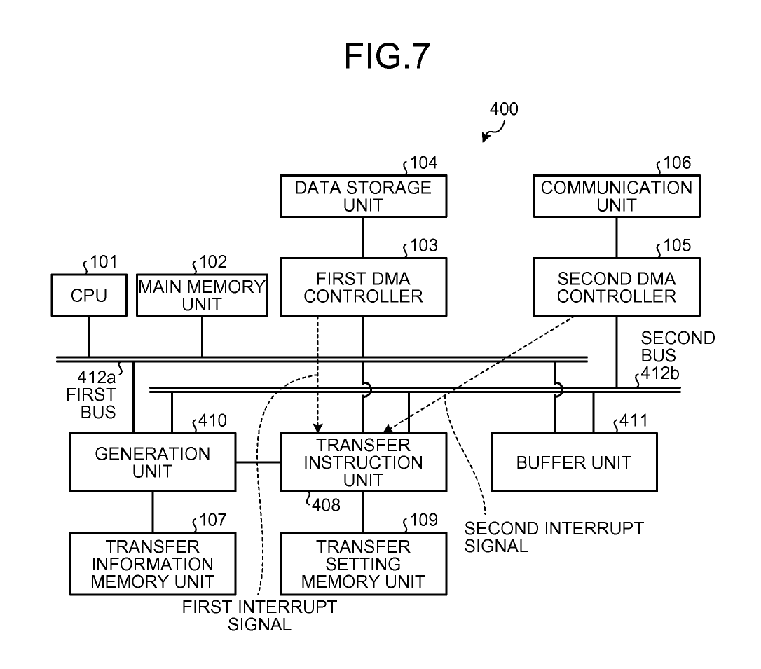

FIG. 7 is a diagram illustrating a form of a data transmission device 400 according to the fourth embodiment. A CPU 101, a main memory unit 102, a first DMA controller 103, a first port of the transfer instruction unit 408, a first port of the generation unit 410, and a first port of the buffer unit 411 are connected to the first bus 412a. A second DMA controller 105, a second port of the transfer instruction unit 408, a second port of the generation unit 410, and a second port of the buffer unit 411 are connected to the second bus 412b. Although in the fourth embodiment, the CPU 101 and the main memory unit 102 are not connected to the second bus 412b, the CPU 101 and the main memory unit 102 may be connected to the second bus 412b.

Different addresses are mapped on the first and second ports of the generation unit 410. The transfer instruction unit 408 sets the address of the generation unit 410 as a reference source to be set in each of the first DMA controller 103 and the second DMA controller 105 to the address corresponding to each port such that the first DMA controller 103 and the second DMA controller 105 can be appropriately connected to the connection-target ports. With this, the generation unit 410 can determine data of a portion of the transfer instruction information where the partial transfer instruction information should be generated depending on the ports at which the reference request is received.

In this way, the bus is divided into the two buses 412a and 412b, and the ports of the devices related to data transfer such as the transfer instruction unit 408, the generation unit 410, the buffer unit 411, and the like involved in data transfer are provided for every bus. Accordingly, data transfer which is performed by the two DMA controllers or the transfer settings by the transfer instruction unit 408 can be executed simultaneously, thereby increasing the data transfer rate. The operation frequency of the bus required for satisfying a desired data transfer rate can be lowered compared to the other embodiments, thereby reducing power consumption of the data transmission device.

### Fifth Embodiment

In a fifth embodiment, an example where data is received from another device through a communication unit 106 and stored in a buffer unit 111 temporarily, and then data transfer is performed from the buffer unit 111 to a data storage unit 104 is described. In this case, since a transfer instruction unit 108 on the reception side has no size information of received data, a case where size information of data when a generation unit 510 generates partial transfer instruction information is not stored in the transfer setting memory unit 109 is described.

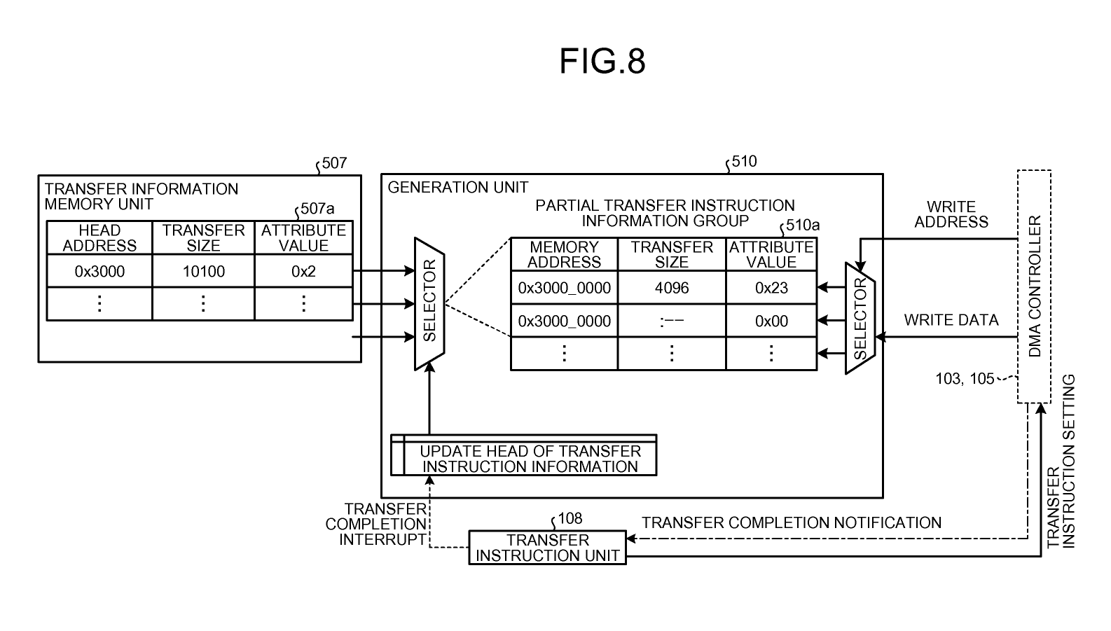

FIG. 8 is a diagram illustrating a generation unit 510 in a data transmission device 500 according to the fifth embodiment. A partial transfer instruction information group 510a in FIG. 8 represents a state where the first entry has been transferred, while the second entry has not yet been transferred. The memory address in the partial transfer instruction information group 510a represents a position where received data is written in the data storage unit 104. When the memory address is identical between the first entry and the second entry, for convenience of explanation, this assumes the FIFO format.

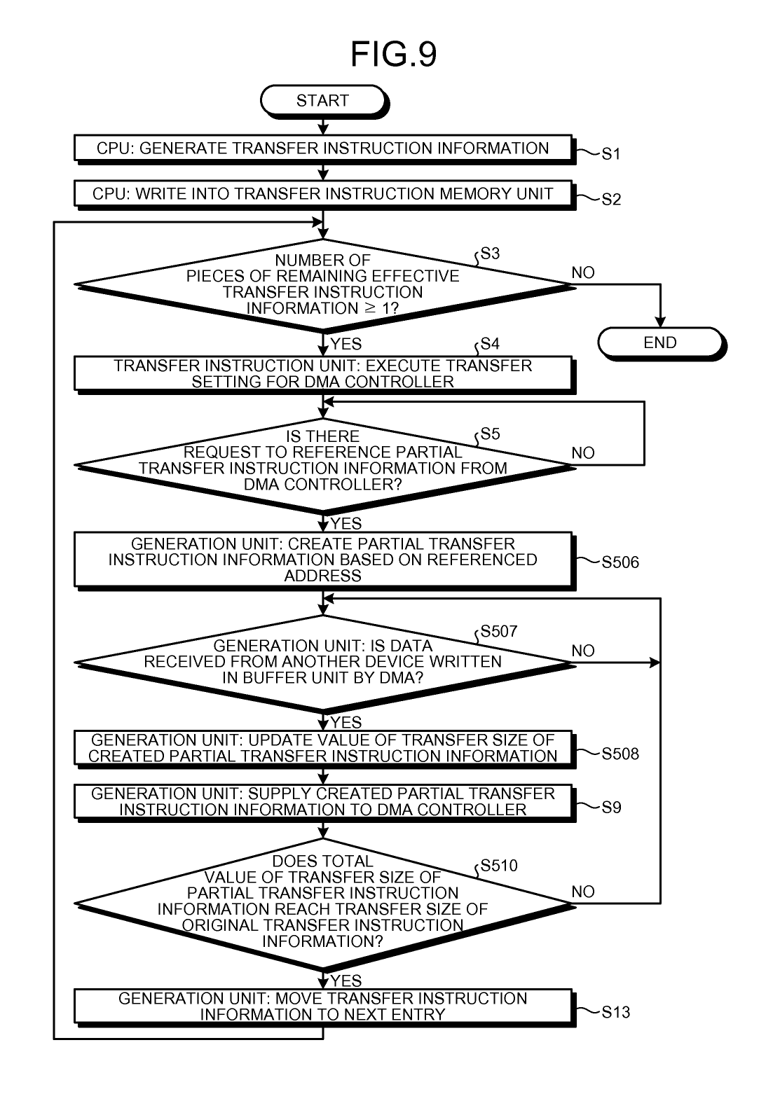

FIG. 9 is a flowchart illustrating the flow of processing for data transfer according to the fifth embodiment. In FIG. 9, the same steps as in FIG. 3 are represented by the same reference numerals, and description thereof will not be repeated. Hereinafter, description will be provided focusing on the steps different from FIG. 3. When control is performed such that data received by the DMA controllers 103 and 105 is transferred to and written in the data storage unit 104, a reference request is made to the address of the generation unit 510 set in Step S4.

When there is a reference request to the address designated from each of the DMA controllers 103 and 105, the generation unit 510 generates partial transfer instruction information, in which the transfer size and attribute values are not defined, from a portion of the transfer instruction information corresponding to the address (Step S506). Each of the DMA controllers 103 and 105 writes the data size or attribute value of data received through the communication unit 106 in the partial transfer instruction information generated at the designated address.

The generation unit 510 determines whether the transfer size or the like of data received from the DMA controller is notified (Step S507). When it is determined that the data size or the like is notified (Yes in Step S507), the generation unit 510 updates the fields of the undefined transfer size and the like of the partial transfer instruction information (Step S508). When it is determined that the data size or the like are not notified (No in Step S507), the generation unit 510 waits until the transfer size is notified from the DMA controller. The generation unit 510 transmits the partial transfer instruction information with the updated transfer size to the DMA controller 103 or 105, and the DMA controller 103 or 105 controls data transfer from the buffer unit 111 to the data storage unit 104 in accordance with the received partial transfer instruction information.

Next, the generation unit 510 determines whether the total value of the transfer size of the partial transfer instruction information reaches the value of the transfer size of the transfer instruction information of the current entry (Step S510). When it is determined that the total value of the transfer size of the partial transfer instruction information reaches the value of the transfer size of the transfer instruction information of the current entry (Yes in Step S510), since transfer related to the transfer instruction information of the current entry is completed, the generation unit 510 updates the entry of the transfer instruction information to the next entry (Step S13). When it is determined that the total value of the transfer size of the partial transfer instruction information does not reach the value of the transfer size of the transfer instruction information of the current entry (No in Step S510), the processing from Step S507 is repeated.

As described above, since the value of the transfer size of the partial transfer instruction information is updated from the data size of data actually received by the DMA controller, even when the size of data to be transferred is not clear in the device on the reception side, it is possible to perform data transfer.

The functions of the generation unit and the transfer instruction unit in the data transmission device of the foregoing embodiments may be provided as a program. In this case, the program may be recorded in a computer-readable recording medium, such as a CD-ROM, a flexible disk (FD), a CD-R, or a DVD (Digital Versatile Disk), as files of an installable format or an executable format and provided.

The program may be stored on a computer connected to a network, such as Internet, downloaded through the network, and provided. The program may be provided or distributed through a network, such as Internet.

The program may be incorporated in a ROM or the like in advance and provided.

Meanwhile, when the generation unit and the transfer instruction unit are provided as a program, as actual hardware, an electronic circuit or a processor different from the CPU (processor) reads from the program from a storage medium and executes the program, such that the respective units are loaded on the main memory unit, and the generation unit and the transfer instruction unit are generated on the main memory unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data transmission device comprising:
a processor;
a memory controller configured to control read and write operations during data transfer between memory devices that store data;
an information memory unit configured to store therein transfer instruction information generated by the processor, the transfer instruction information including: positional information related to a position where data is stored in the memory device as a read source or a write destination of the data; and size information of the data;
a generation unit configured to divide the transfer instruction information into predetermined data size pieces to generate a plurality of pieces of partial transfer instruction information; and
an instruction unit configured to instruct the memory controller to acquire a piece of the partial transfer instruction information.

2. The device according to claim 1, wherein
the instruction unit designates, with respect to the memory controller, a content of an instruction for a determination of from which portion of the transfer instruction information the generation unit generates the pieces of the partial transfer instruction information;
the memory controller makes, on the basis of the content of the instruction, a request to the generation unit for an acquisition of the piece of the partial transfer instruction information; and
the generation unit makes, in accordance with the request for the acquisition, a determination of from which portion of the transfer instruction information the pieces of the partial transfer instruction information are generated; and generates the pieces of the partial transfer instruction information in accordance with the determination.

3. The device according to claim 1,
wherein the generation unit generates the partial transfer instruction information in different formats in accordance with whether there is any reference from the memory controller.

4. The device according to claim 3,
wherein a plurality of the memory controllers are provided, and
the instruction unit and the memory controllers are connected by a plurality of different buses.

5. The device according to claim 4,
wherein a plurality of the generation units are provided, and
wherein the generation units and the memory controllers are connected by a plurality of different buses.

6. The device according to claim 1,
wherein the instruction unit to acquire the partial transfer instruction information, and controls data transfer based on the acquired partial transfer instruction information.

7. The device according to claim 1,
wherein when there is a request to acquire the partial transfer instruction information from the memory controller, the generation unit generates the partial transfer instruction information in which the size information is not defined, and after the memory controller controls data write operation, acquires the size information of data during write operation received from the memory controller to update the size information.

8. A data transmission method for a device which includes processor and a memory controller that controls read and write operations during data transfer between memory devices that stores data, the method comprising:
storing transfer instruction information generated by the processor, the transfer instruction information including: positional information related to a position where data is stored in the memory device as a read source or a write destination of the data; and size information of the data;
dividing the transfer instruction information into predetermined data size pieces to generate a plurality of pieces of partial transfer instruction information; and
instructing the memory controller to acquire a piece of the partial transfer instruction information.

9. A computer program product comprising a computer-readable medium containing a program that causes a computer including processor and a memory controller which controls read and write operations during data transfer between memory devices which stores data, to execute:
storing transfer instruction information generated by the processor, the transfer instruction information including: positional information related to a position where data is stored in the memory device as a read source or a write destination of the data; and size information of the data;
dividing the transfer instruction information into predetermined data size pieces to generate a plurality of pieces of partial transfer instruction information; and
instructing the memory controller to acquire a piece of the partial transfer instruction information.
